(19) United States
(12) Patent Application Publication
(10) Pub. No.: US 2025/0259433 A1
(43) Pub. Date: Aug. 14, 2025

(54) METHOD AND APPARATUS FOR TRAINING A MACHINE LEARNING MODEL

(71) Applicant: Robert Bosch GmbH, Stuttgart (DE)

(72) Inventors: Jan Fabian Schmid, Hamburg (DE); Andre Wagner, Hannover (DE); Annika Hagemann, Hildesheim (DE)

(21) Appl. No.: 19/048,013

(22) Filed: Feb. 7, 2025

(30) Foreign Application Priority Data
Feb. 13, 2024 (DE) 10 2024 201 292.0

(51) Int. Cl. G06V 10/82; G06V 10/46; G06V 10/74; G06V 10/762; G06V 10/77; G06V 10/776; G06V 10/98

(52) U.S. Cl. CPC G06V 10/82; G06V 10/46; G06V 10/761; G06V 10/762; G06V 10/7715; G06V 10/776; G06V 10/98

(57) ABSTRACT

A method and an apparatus for training a machine learning model comprising a first and a second deep neural network.

### FIELD

The present invention relates to a method and an apparatus for training a machine learning model comprising a first and a second deep neural network.

### BACKGROUND INFORMATION

In modern image processing and computer vision, methods for extracting local image features play an important role. These techniques are important for a wide range of applications, from automated image recognition to 3D reconstruction to robotics. In order to be effective, the image feature extraction methods must be carefully developed to possess certain properties, in particular with regard to determining the relative position of one image in comparison to another image.

One of the key aspects in this area is the robustness of keypoint detection against different types of changes, such as changes in perspective, changes in appearance due to different recording conditions or changes in the environment. This robustness is crucial since it ensures that, despite these challenges, the important points, the so-called keypoints, can be recognized consistently and reliably.

In addition to robustness, even distribution of the keypoints over the entire image is another important criterion. Clump-free, homogeneous distribution of the keypoints makes it possible to more comprehensively and more representatively detect the information contained in an image.

Another critical factor is the quality of the descriptors of the keypoints. Descriptors that describe corresponding keypoints should be highly similar, while descriptors for non-corresponding keypoints should be as different as possible. This makes it possible to effectively match features, which forms the basis for subsequent applications such as camera pose determination.

Integrating these properties “by design” into image feature extraction methods, such as in SIFT (Lowe, 2004) or by learning appropriate cost functions in newer methods such as SuperPoint (DeTone et al., 2018) and KP2D (Tang et al., 2020), has proven to be crucial. In particular, the learned image feature extraction methods have often proven to be superior to the manually constructed alternatives, which is primarily due to the more complex image processing operators developed during training and adjusted to the specific data.

In addition, image reconstruction on the basis of local image features, as researched for example by Jin et al. (2022) “TUSK: Task-agnostic unsupervised Keypoints,” is an established method. In this case, local image features are used to reconstruct the original image.

Even though a plurality of approaches are already described in the related art, there is still potential for development.

### SUMMARY

It is an object of the present invention to provide an improved method and an improved apparatus for training a machine learning model.

The object may be achieved by a method for training a machine learning model having certain features of the present invention. The object may be achieved by an inference method for image feature extraction from images for determining the relative poses of image contents having certain features of the present invention. The object may be achieved by an apparatus for training a machine learning model having certain features of the present invention.

According to a first aspect of the present invention, a method for training a machine learning model comprising a first and a second deep neural network is specified. According to an example embodiment of the present invention, the method comprises the steps of:
providing two training images, which at least partially comprise the same or similar image contents, wherein the two training images depict the image contents from different perspectives and/or at different points in time;
processing the two training images by the first deep neural network in such a way that image features are extracted from the two training images by setting corresponding keypoints in the two training images and describing the corresponding keypoints with the same or similar descriptors;
matching the extracted image features of the two training images, wherein the image features with the same or similar descriptors are matched to form image feature pairs;
for each matched image feature pair,
extracting information of the keypoint from one of the two training images and information of the descriptor from the other of the two training images;
reconstructing the one of the two training images, for which information of the respective keypoints of the matched image feature pairs was extracted, by the second deep neural network on the basis of the extracted information of the respective keypoints and on the basis of the extracted information of the respective descriptors of the matched image feature pairs;
quantifying differences between the reconstructed training image and the provided one of the two training images by means of a cost function;
adjusting parameters of the first and/or the second deep neural network based on the quantified differences, for optimizing the cost function for providing a trained machine learning model.

It is understood that the steps according to the present invention as well as other optional steps do not necessarily have to be carried out in the order shown, but can also be carried out in a different order. Other intermediate steps can also be provided. The individual steps can also comprise one or more sub-steps without departing from the scope of the method according to the present invention.

According to a second aspect of the present invention, an apparatus for training a machine learning model comprising a first and a second deep neural network is specified. According to an example embodiment of the present invention, the apparatus comprises an evaluation and computing device, which is designed to perform the following steps:
providing two training images, which at least partially comprise the same or similar image contents, wherein the two training images depict the image contents from different perspectives and/or at different points in time;
processing the two training images by the first deep neural network in such a way that image features are extracted from the two training images by setting corresponding keypoints in the two training images and describing the corresponding keypoints with the same or similar descriptors;
matching the extracted image features of the two training images, wherein the image features with the same or similar descriptors are matched to form image feature pairs;
for each matched image feature pair,
extracting information of the keypoint from one of the two training images and information of the descriptor from the other of the two training images;
reconstructing the one of the two training images, for which information of the respective keypoints of the matched image feature pairs was extracted, by the second deep neural network on the basis of the extracted information of the respective keypoints and on the basis of the extracted information of the respective descriptors of the matched image feature pairs;
quantifying differences between the reconstructed training image and the provided one of the two training images by means of a cost function;
adjusting parameters of the first and/or the second deep neural network based on the quantified differences, for optimizing the cost function for providing a trained machine learning model.

The explanations given for the method of the present invention apply accordingly to the apparatus of the present invention. The apparatus can be part of a system. It is understood that linguistic modifications of features formulated for the method can be reformulated for the apparatus in accordance with standard linguistic practice, without such formulations having to be explicitly listed here.

A method according to the present invention for training a machine learning method that is used in particular for the extraction of preferably local image features is thus described herein. The features are in particular suitable for determining the relative poses of images or between multiple images. Pose is understood to mean the position and orientation of an image feature that at least partially represents an image content. In the following, the term “deep neural network” is used to represent any machine learning method.

Each image feature comprises at least one keypoint, which specifies the image coordinates of the image feature. Each image feature comprises at least one descriptor, which describes the in particular local environment of the keypoint in the image.

By assigning or matching corresponding image features between the at least two training images, which at least partially show the same or a similar environment, a camera pose of one image relative to another image can be determined, for example. Preferably, two image features are considered to correspond if they characterize the same point in the real 3D world that is visible in the different training images. A model trained according to the method can be used, purely by way of example, for the self-localization of (autonomous) vehicles, drones and/or robots.

From each matched image feature pair, the descriptor of the corresponding image feature is preferably extracted from one of the two images and the keypoint of the matched image feature is extracted from the other of the two images. The idea here is that geometric information can be ascertained from one of the two images in this way. On the other hand, photometric information in particular can be ascertained from the other of the two images. Since the matched image features preferably represent the same physical locations of the environment, a descriptor of an image feature from the other of the two images is also a suitable descriptor for the corresponding image feature from the one of the two images. The collected information about the matched image features is preferably passed as input to the second deep neural network. The goal of this network is to create the most accurate possible reconstruction of the one of the two images.

The method of the present invention described here for training a machine learning model for image feature extraction for localization is particularly frugal in the requirements for the training data or training images used. Preferably, only image pairs are required that at least partially or in regions represent the same or a similar environment, in particular when viewed at a threshold value. For example, no precise camera poses are required for object localization on the basis of the (training) images. This property facilitates the use or inference of the trained model and thus makes scaling possible for training on large data sets (e.g., >1000 image pairs). This makes the present training approach suitable for training a foundation model (also called a base model).

In particular, the method is based on information about the matched image features between the two training images being used to reconstruct one of the two images. For this purpose, two deep neural networks are trained, in particular independently of each other. The first network extracts the, preferably local, image features. The second network uses the matches between the image features of two images for image reconstruction.

Image reconstruction describes the task that is achieved in particular in a self-supervised manner during training. Image reconstruction is thus not necessarily the goal of the training. The goal of training or the ability of the trained model is preferably to determine the image features in such a way that the resulting matches are suitable for image reconstruction. This in turn is the case if the image features are suitable for localization tasks. The trained model has preferably learned in a supervised manner to perform image feature extraction based on the matching. The present invention is based on matching image features between two different images and subsequently using the information from these matches for the reconstruction. The matching used here is preferably differentiable.

The object of the method described in the present invention is to train at least one deep neural network to extract image features from an image in a way that makes determining the relative poses between at least two images possible. The model or network trained here is convincing through comparatively better pose determination performance and can also be adjusted to any pose determination use case easily, namely by appropriately selecting the training images.

In comparison to other machine learning methods for training deep neural networks for image feature extraction, the properties for image feature extraction are not learned through a suitable cost function, which, for example, enforces that descriptors of corresponding image features and/or keypoints obtain descriptors that are as similar as possible, as would be the case with contrastive loss, for example. Rather, the properties here result implicitly from the task that is achieved during training.

A disadvantage of explicit cost functions from the related art is that they are “manually constructed” by a person. There are a variety of ways to construct the costs for the same goal. Thus, it is unlikely that the best possible variant of the cost function is selected with this manual approach. In addition, manually created cost functions must be weighted. This involves additional hyperparameters that typically have to be set correctly manually. When using cost functions, many decisions must thus be made that depend on the user's intuition.

The present training method is decoupled therefrom. The task of image reconstruction on the basis of matched, in particular local, image features intrinsically requires that image feature matching works well. Image feature matching works here if keypoints are found in the at least two (training) images at the correspondingly same locations in the two images and if the descriptors of these corresponding keypoints are the same or similar, while the descriptors of non-corresponding keypoints are different. In addition, even distribution of the keypoints in each image is advantageous, since more information for the reconstruction is available as a result.

The method, in which the desired properties of the trained model result implicitly from the task achieved during training, could alternatively also be obtained by training a deep neural network directly for a localization task. However, the disadvantage of such an alternative approach is that the correct solution, i.e., for example, a relative camera position and/or orientation between two images, must be known so that this can be used as a ground-truth training method. However, such an accurate ground truth for camera poses is often not directly available. Furthermore, it is technically complex to generate these camera poses, e.g., by means of structure-from-motion methods.

The method according to the present invention presented here does not require such camera poses, since an error between an actual image and a reconstruction of this image is exploited.

The advantage over other related-art methods is that the described method is self-supervised, i.e., a precise solution for the localization task to be achieved does not have to be known in advance, although the deep neural network determines a correspondence between real and reconstructed image pairs during training. This is also a difference to other self-supervised methods that do not use real image pairs during training, but use image pairs that are artificially generated through homography warping and for which the true image feature correspondences can be determined on the basis of the known homography. The use of real image pairs, on the other hand, has the advantage that real variations in the appearance of the same or a similar environment or image contents can be learned.

The (training) images are preferably detected and provided by an optical sensor. The images can be preprocessed or be present as raw data detected by the sensor. The sensor can be a camera, a lidar sensor, a radar sensor, an ultrasonic sensor, an infrared sensor or another imaging sensor.

The image pairs used for training preferably have at least partially the same image contents, i.e., they show, for example, the same environment, e.g., images recorded by tourists in front of the Eiffel Tower or in front of a certain mountain range. On the other hand, the image pairs used for training are preferably not identical, but they show the environment from a different perspective and/or at a different point in time.

Instead of real image pairs, image pairs of which one or both were generated synthetically can also be used. Such image pairs can be part of a pre-training. Synthetically generated image pairs can be generated by artificial transformations, such as homographies.

In one example embodiment of the present invention, for providing the trained machine learning model, the aforementioned steps of processing, matching, extracting, reconstructing and quantifying are at least partially repeated iteratively until a termination criterion or a threshold value of the cost function is reached.

In one example embodiment of the present invention, the cost function ascertains an error between the reconstructed training image and the provided one of the two training images on the basis of the quantified differences.

In one example embodiment of the present invention, the cost function ascertains the error as the sum of pixel differences between the reconstructed training image and the provided one of the two training images as a photometric error.

The cost function of the training method is thus preferably based on the photometric difference between the actual and the reconstructed image, so that the true relative pose between the images is not needed for the training. The cost function is preferably evaluated by assessing the photometric difference between the reconstructed and the associated original image. In so doing, the sum of the pixel value differences of pixels with the same image coordinates can be calculated. On the basis of the costs of image reconstruction, the gradients for a gradient descent method for training the first deep neural network are preferably calculated (backpropagation). Since both the first and the second deep neural network and/or the feature matching are preferably differentiable, the method is a method that can be trained end to end. That is to say, the costs of the output are used to adjust the parameters of the first and the second deep neural network and possibly also of the matching method in such a way that the costs for the same input (an image) are lower in the future. As an alternative to the photometric error, a perceptual similarity can also be considered.

In one example embodiment of the present invention, the corresponding keypoints are set at the same or similar locations of the two training images.

In one example embodiment of the present invention, the first deep neural network comprises an encoder, and the second deep neural network comprises a decoder.

The first deep neural network, the encoder, preferably determines the image features for the two training images. The architecture of the encoder can be selected to be similar to a KP2D structure as revealed by Tang et al. (2020) “Neural outlier rejection for self-supervised keypoint learning.” However, the KP2D training method is not adopted or is only used as a pre-training, so that the encoder can already extract image features. The image feature extraction can then be further improved by means of the present training method.

In one example embodiment of the present invention, a plurality of two training images, each preferably representing image pairs of the same or similar image content, is provided.

The number of training images used for the training can preferably be selected depending on a use case and/or a required performance. After the described training method has been performed with a large number of image pairs, the first deep neural network, in particular the encoder, can preferably be used for image feature extraction independently of the other components. For example, the trained first deep neural network can be used in an autonomous vehicle that localizes itself in its environment by means of the image feature correspondences between a current image and a, for example previously, recorded image. The described method, which is also used during training and is possibly also adjusted in the inference, can also be used for feature matching.

In one example embodiment of the present invention, processing the two training images by the first deep neural network furthermore comprises calculating an image descriptor at least for one of the two training images. The reconstruction of the one of the two training images is preferably also carried out on the basis of the image descriptor associated with the one or the same of the two training images.

In this example embodiment of the present invention, the first deep neural network preferably calculates an image descriptor, i.e., a compact d-dimensional representation of the image, in addition to the local image features. Such image descriptors are used, for example, for place recognition tasks, in which images with at least partially identical contents comprise similar image descriptors. In contrast to local image features, image descriptors are not suitable for precisely determining the relative poses between two images. The image descriptor, determined by the first network, of the one of the two images is preferably additionally provided to the second network for generating the reconstruction. This is a way for the second network to obtain information about the style of the image to be reconstructed, e.g., that the image is an image recorded at night and/or in winter. Since the second network otherwise only obtains photometric information from the other image, the second network can otherwise only use the style of the other image for the reconstruction, which style may however differ greatly from the actual style of the image to be reconstructed. This variant of the present invention thus has the additional advantage that the image descriptors determined by the first network can be used for a first rough localization before a precise localization is subsequently performed on the basis of the local image features.

In one example embodiment of the present invention, each pixel or at least a plurality of pixels or at least a predetermined grid of pixels or every n-th pixel, where n>1, of the two training images in each case defines a keypoint.

The present method can highlight only a small portion of the pixels in an image by means of keypoints and consider only these keypoints during matching. On the other hand, a dense method can also be used, in which every pixel or every n-th number of pixels is used as a keypoint. The resolution of the (input) image is preferably reduced so that the computational load does not become too great.

The method can also be used (e.g., in the dense variant) for self-supervised training of a foundation model. This model preferably learns to, on the basis of large data volumes, extract local image features that are suitable for subsequent 3D image processing tasks (such as video-based localization).

An inference method for extracting image features from images for determining the relative poses of image contents is also specified here. According to an example embodiment of the present invention, the inference method comprises:
providing two images, which are preferably each detected by an optical sensor;
extracting image features from the provided images by a machine learning model trained according to the present method;
determining the relative poses of image contents of the two images on the basis of the extracted image features by the machine learning model trained according to the present method.

Particularly preferably, the inference method is used for environmental localization and/or for self-pose determination on the basis of the relative pose determination of image contents for an automated driving function of a motor vehicle, an automated function of a drone or an automated function of a robot. The inference method can be used, for example, for video-based ego motion estimation for use in the field of autonomous parking.

Also provided according to the present invention is a control unit, which is comprised for a semi-automated or automated driving function of a motor vehicle and/or a drone and/or in a robotic system and/or in an industrial machine and/or is used for optical inspection, and on which a machine learning model trained according to the present invention is executable.

In the present case, the present invention also provides a computer program having program code to execute at least parts of the method according to the present invention in one of its embodiments when the computer program is executed on a computer. In other words, according to the present invention, a computer program (product) comprising commands that, when the program is executed by a computer, cause the computer to carry out the method/steps of the method according to the present invention in any of its embodiments.

The present invention also provides a computer-readable data carrier having program code of a computer program to execute at least parts of the method according to the present invention in one of its embodiments when the computer program is executed on a computer. In other words, the present invention relates to a computer-readable (memory) medium comprising commands that, when executed by a computer, cause the computer to perform the method/steps of the method according to the present invention in one of its embodiments.

The described embodiments and developments of the present invention can be combined with one another as desired.

Further possible embodiments, developments and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the embodiments of the present invention. They illustrate example embodiments and, in connection with the description, serve to explain principles and concepts of the present invention.

Other embodiments and many of the mentioned advantages are apparent from the figures. The illustrated elements of the figures are not necessarily shown to scale relative to one another.

FIG. 1 is a schematic flowchart of the present training method, according to an example embodiment of the present invention.

FIG. 2 is a schematic block diagram of the present training method according to an example embodiment of the present invention.

FIG. 3 is a schematic block diagram of the present training method according to another example embodiment of the present invention.

### DETAILED DESCRIPTION OF EXAMPLE EMBODIMENTS

In the figures, identical reference signs denote identical or functionally identical elements, parts or components, unless stated otherwise.

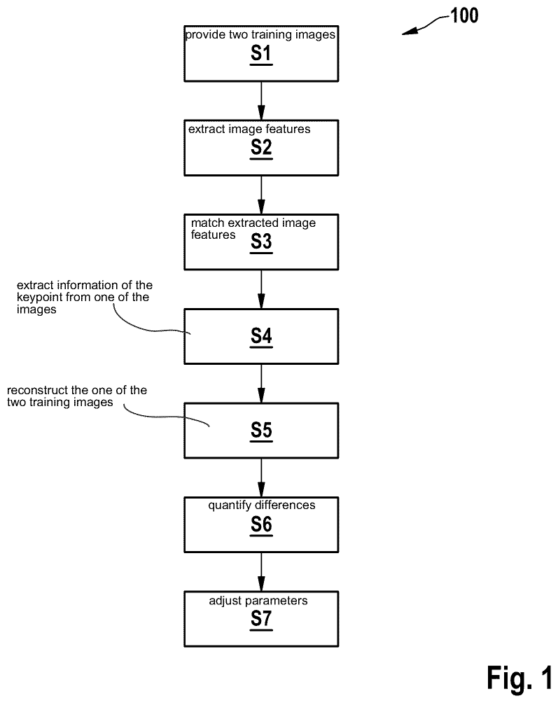

FIG. 1 is a schematic flowchart of an exemplary method for training a machine learning model comprising a first deep neural network and a second deep neural network.

In any embodiment, the method can be carried out at least partially by an apparatus 100 that can comprise, for this purpose, multiple components (not represented in detail), for example one or more provision devices and/or at least one evaluating and computing device. It is understood that the provision device can be designed together with the evaluation and computing device or can be different therefrom. Furthermore, the system can comprise a storage device and/or an output device and/or a display device and/or an input device.

The preferred computer-implemented method for training comprises at least the following steps:

In a step S1, two training images are provided, which at least partially comprise the same or similar image contents, wherein the two training images depict the image contents from different perspectives and/or at different points in time.

In a step S2, the two training images are processed by the first deep neural network in such a way that image features are extracted from the two training images by setting corresponding keypoints in the two training images and describing the corresponding keypoints with the same or similar descriptors.

In a step S3, the extracted image features of the two training images are matched, wherein the image features with the same or similar descriptors are matched to form image feature pairs.

For each matched image feature pair, the following steps are preferably performed at least once, preferably also iteratively:

In a step S4, information of the keypoint is extracted from one of the two training images and information of the descriptor is extracted from the other of the two training images.

In a step S5, the one of the two training images, for which information of the respective keypoints of the matched image feature pairs was extracted, is reconstructed by the second deep neural network on the basis of the extracted information of the respective keypoints and on the basis of the extracted information of the respective descriptors of the matched image feature pairs.

In a step S6, differences between the reconstructed training image and the provided one of the two training images is quantified by means of a cost function.

In a step S7, parameters of the first and/or the second deep neural network are adjusted based on the quantified differences, for optimizing the cost function for providing a trained machine learning model.

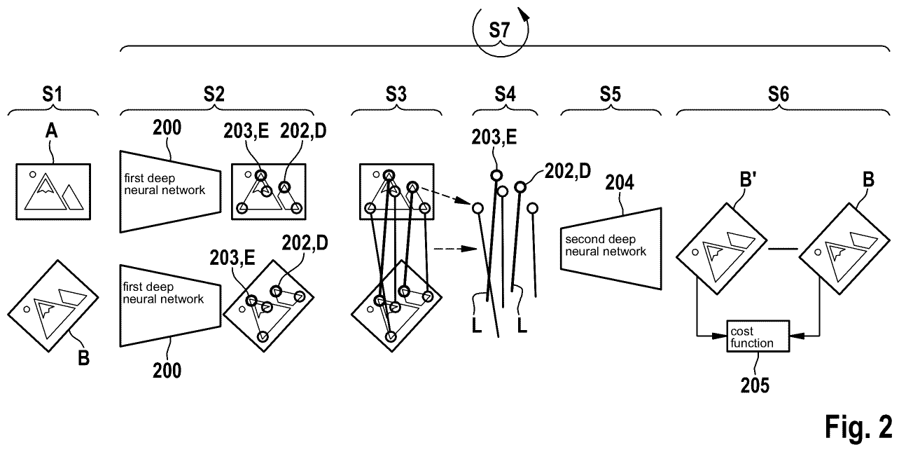

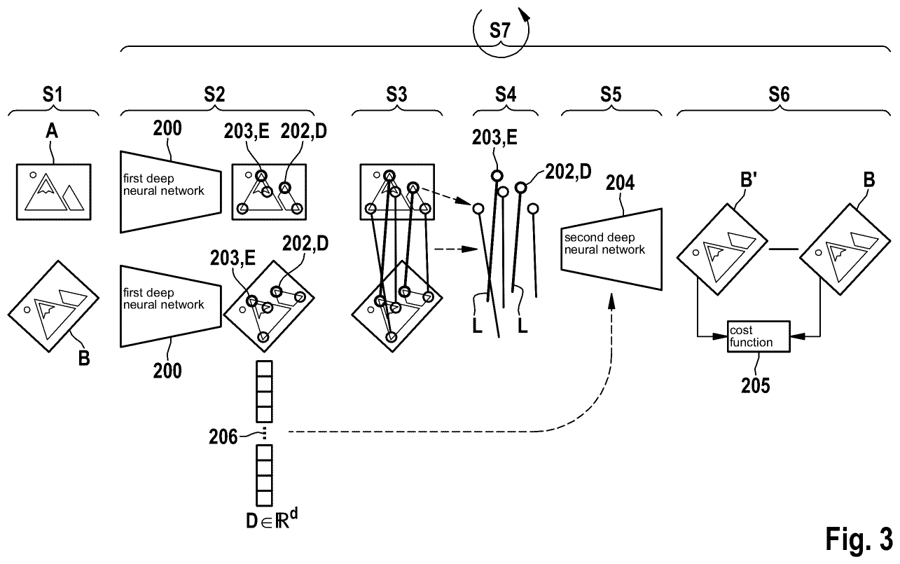

FIG. 2 is a schematic block diagram of an exemplary embodiment of the present method. Two training images A and B (hereinafter also referred to as images A and B) show at least partially the same or similar image contents, for example from different perspectives and/or at different (recording) times. The training images are each processed by the first deep neural network 200, an encoder. This network 200 extracts local image features from the training images with the aim of determining corresponding image features. Keypoints 202, 203 (circles in FIGS. 2 and 3) are set at approximately the same locations in the training images A, B and are each described (per image) with similar descriptors D, E. In FIG. 2 and FIG. 3, the descriptor values are different for each of the circles per training image A, B. The keypoints 202 marked in FIGS. 2 and 3 are described per image A, B by an identical or similar descriptor D. The keypoints 203 marked in FIGS. 2 and 3 are described per image A, B by an identical or similar descriptor E. The positions of the circles correspond to the keypoints 202, 203.

In the next step, differentiable matching between the image features from images A and B is performed. The corresponding features with similar descriptor values D, E are matched to form pairs. The matched pairs are connected by lines L in the figure.

For each matched image feature pair from images A, B, information of the corresponding keypoint 202, 203 in image B, as well as the descriptor D, E from image A, are extracted. This information is passed to a second deep neural network 204, a decoder.

The second network 204 reconstructs image B on the basis of the extracted information (keypoints 202, 203 from image B, with descriptors D, E from image A).

A cost function 205 quantizes the made error on the basis of the differences between the reconstruction B′ of image B and the actual image B, e.g., as the sum of the pixel differences between B′ and B (photometric error).

FIG. 3 is a schematic block diagram of an exemplary embodiment of the present method. In contrast to FIG. 1, this variant provides additional information about the appearance of image B for the reconstruction. In this example, image B shows the environment shown in image A not only from a different perspective, but the appearance has also changed, for example because the season and/or the recording time has changed. Since the second network 204 only had keypoints 202, 203 from image B and descriptors D, E from image A available for the reconstruction so far, there is no way to predict the change in appearance. For this purpose, according to this variant, the first network 200 determines, in addition to the local image features, an image descriptor 206 for image B, which image descriptor is additionally provided to the second network 204 as input for the reconstruction.

1-15. (canceled)

16. A method for training a machine learning model including a first deep neural network and a second deep neural network, the method comprising the following steps:
(S1) providing two training images, which at least partially include the same or similar image contents, wherein the two training images depict the image contents from different perspectives and/or at different points in time;
(S2) processing the two training images by the first deep neural network in such a way that image features are extracted from the two training images by setting corresponding respective keypoints in the two training images and describing the corresponding respective keypoints with the same or similar descriptors;
(S3) matching the extracted image features of the two training images, wherein the image features with the same or similar descriptors are matched to form image feature pairs; and
for each matched image feature pair,
(S4) extracting information of the respective keypoint from one of the two training images and information of the descriptor from the other of the two training,
(S5) reconstructing the one of the two training images, for which information of the respective keypoints of the matched image feature pairs was extracted, by the second deep neural network based on the extracted information of the respective keypoints and based on the extracted information of the respective descriptors of the matched image feature pairs,
(S6) quantifying differences between the reconstructed training image and the provided one of the two training images using a cost function, and
(S7) adjusting parameters of the first and/or the second deep neural network based on the quantified differences, for optimizing the cost function for providing a trained machine learning model.

17. The method according to claim 16, wherein, for providing the trained machine learning model, steps S2 to S7 are repeated at least partially iteratively until a termination criterion or a threshold value of the cost function is reached.

18. The method according to claim 16, wherein the cost function ascertains an error between the reconstructed training image and the provided one of the two training images based on the quantified differences.

19. The method according to claim 18, wherein the cost function ascertains the error as a sum of pixel differences between the reconstructed training image and the provided one of the two training images as a photometric error.

20. The method according to claim 16, wherein the respective keypoints are set at the same or similar locations of the two training images.

21. The method according to claim 16, wherein the first deep neural network includes an encoder and the second deep neural network includes a decoder.

22. The method according to claim 16, wherein a plurality of two training images, each representing image pairs of the same or similar image content, is provided.

23. The method according to claim 16, wherein the processing of the two training images by the first deep neural network further includes: calculating an image descriptor of the one of the two training images; and wherein reconstructing the one of the two training images is also carried out based on the image descriptor associated with the one of the two training images.

24. The method according to claim 16, wherein each pixel of the two training images defines a keypoint.

25. An inference method for extracting image features from images for determining relative poses of image contents, the method comprising the following steps:
providing two images which are each detected by an optical sensor;
extracting image features from the provided images by a machine learning model trained by:
(S1) providing two training images, which at least partially include the same or similar image contents, wherein the two training images depict the image contents from different perspectives and/or at different points in time;
(S2) processing the two training images by a first deep neural network of the machine learning model in such a way that image features are extracted from the two training images by setting corresponding respective keypoints in the two training images and describing the correspondng respective keypoints with the same or similar descriptors;
(S3) matching the extracted image features of the two training images, wherein the image features with the same or similar descriptors are matched to form image feature pairs; and
for each matched image feature pair,
(S4) extracting information of the respective keypoint from one of the two training images and information of the descriptor from the other of the two training,
(S5) reconstructing the one of the two training images, for which information of the respective keypoints of the matched image feature pairs was extracted, by a second deep neural network of the machine learning model based on the extracted information of the respective keypoints and based on the extracted information of the respective descriptors of the matched image feature pairs,
(S6) quantifying differences between the reconstructed training image and the provided one of the two training images using a cost function, and
(S7) adjusting parameters of the first and/or the second deep neural network based on the quantified differences, for optimizing the cost function for providing a trained machine learning model;
determining the relative poses of image contents of the two images based on the the extracted image features by the trained machine learning model trained.

26. The inference method according to claim 25, wherein the inference method is for environmental localization and/or for self-pose determination based on the relative pose determination of the image contents for an automated driving function of a motor vehicle or an automated function of a drone or an automated function of a robot.

27. An apparatus for training a machine learning model including a first deep neural network and a second deep neural network, the apparatus comprising an evaluation and/or computing device designed to perform the following steps:
(S1) providing two training images, which at least partially include the same or similar image contents, wherein the two training images depict the image contents from different perspectives and/or at different points in time;
(S2) processing the two training images by the first deep neural network in such a way that image features are extracted from the two training images by setting corresponding respective keypoints in the two training images and describing the corresponding respetive keypoints with the same or similar descriptors;
(S3) matching the extracted image features of the two training images, wherein the image features with the same or similar descriptors are matched to form image feature pairs;
for each matched image feature pair,
(S4) extracting information of the respective keypoint from one of the two training images and information of the descriptor from the other of the two training,
(S5) reconstructing the one of the two training images, for which information of the respective keypoints of the matched image feature pairs was extracted, by the second deep neural network based on the extracted information of the respective keypoints and based on the extracted information of the respective descriptors of the matched image feature pairs,
(S6) quantifying differences between the reconstructed training image and the provided one of the two training images using a cost function,
(S7) adjusting parameters of the first and/or the second deep neural network based on the quantified differences, for optimizing the cost function for providing a trained machine learning model.

28. A control device for: (i) an automated driving function of a motor vehicle and/or (ii) an automated function of a drone and/or (iii) an automated function of a robot and/or (iv) an automated optical inspection of components and/or samples, wherein the control device is configured to execute a machine learning model trained by:
(S1) providing two training images, which at least partially include the same or similar image contents, wherein the two training images depict the image contents from different perspectives and/or at different points in time;
(S2) processing the two training images by a first deep neural network of the machine learning model in such a way that image features are extracted from the two training images by setting corresponding respective keypoints in the two training images and describing the corresponding respective keypoints with the same or similar descriptors;
(S3) matching the extracted image features of the two training images, wherein the image features with the same or similar descriptors are matched to form image feature pairs; and
for each matched image feature pair,
(S4) extracting information of the respective keypoint from one of the two training images and information of the descriptor from the other of the two training,
(S5) reconstructing the one of the two training images, for which information of the respective keypoints of the matched image feature pairs was extracted, by a second deep neural network of the machine learning model based on the extracted information of the respective keypoints and based on the extracted information of the respective descriptors of the matched image feature pairs,
(S6) quantifying differences between the reconstructed training image and the provided one of the two training images using a cost function, and
(S7) adjusting parameters of the first and/or the second deep neural network based on the quantified differences, for optimizing the cost function for providing a trained machine learning model.

29. A non-transotory computer-readable data carrier on which is stored program code of a computer program for training a machine learning model including a first deep neural network and a second deep neural network, the program code, when executed by a computer, causing the computer to perform the following steps:
(S1) providing two training images, which at least partially include the same or similar image contents, wherein the two training images depict the image contents from different perspectives and/or at different points in time;
(S2) processing the two training images by the first deep neural network in such a way that image features are extracted from the two training images by setting corresponding respective keypoints in the two training images and describing the corresponding respective keypoints with the same or similar descriptors;
(S3) matching the extracted image features of the two training images, wherein the image features with the same or similar descriptors are matched to form image feature pairs; and
for each matched image feature pair,
(S4) extracting information of the respective keypoint from one of the two training images and information of the descriptor from the other of the two training,
(S5) reconstructing the one of the two training images, for which information of the respective keypoints of the matched image feature pairs was extracted, by the second deep neural network based on the extracted information of the respective keypoints and based on the extracted information of the respective descriptors of the matched image feature pairs,
(S6) quantifying differences between the reconstructed training image and the provided one of the two training images using a cost function, and
(S7) adjusting parameters of the first and/or the second deep neural network based on the quantified differences, for optimizing the cost function for providing a trained machine learning model.
